(19) United States
(12) Patent Application Publication
(10) Pub. No.: US 2014/0074869 A1
(43) Pub. Date: Mar. 13, 2014

(54) AUTOCLASSIFYING COMPOUND DOCUMENTS FOR ENHANCED METADATA SEARCH

(71) Applicant: Elaine B. Petrone, Raleigh, NC (US)

(72) Inventor: Elaine B. Petrone, Raleigh, NC (US)

(73) Assignee: INTERNATIONAL BUSINESS MACHINES CORPORATION, Armonk, NY (US)

(21) Appl. No.: 13/610,356

(22) Filed: Sep. 11, 2012

(51) Int. Cl. G06F 17/30

(52) U.S. Cl. 707/755; 707/E17.061; 707/E17.032

(57) ABSTRACT

An enterprise content management system provides automatically classified topic-specific metadata from a map file to a set of search properties associated with the topic file. An example includes parsing content from the links in a map file and storing topic-specific metadata as search properties in a content engine.

### TECHNICAL FIELD

The disclosure relates to a content management system, and in particular, to metadata search for a content management system.

### BACKGROUND

An enterprise content management system may have the ability to parse the content of a single file to extract certain portions of the content to populate search properties for that document. This enables users to perform context-specific searching across an enterprise document store. One standard that may be used in an enterprise content management system is Darwin Information Typing Architecture (DITA), which enables content to be reused across various formats and in different contexts and forms of content output or deliverables. Within the DITA standard, content may be divided into map files and topic files (also referred to simply as maps and topics), where a map file contains and organizes links to topic files, and each topic file contains text content focused on a single, narrowly defined subject. A map may also define taxonomic metadata and other metadata for each of the topics. The metadata may be defined at the top of the map to apply to all the topics linked from the map, to a branch of the map to apply to a subset of topics, or to a specific reference to a topic.

### SUMMARY

In general, this disclosure describes techniques for an enterprise content management system that provides automatically classified topic-specific metadata from a map file to a set of search properties associated with the topic file. In one example, a method includes parsing content from the map file and storing topic-specific metadata based on the parsed content from the map file as search properties for the associated topic file in a content engine.

In another example, a computing system includes one or more processors and one or more computer-readable tangible data storage devices. The computing system further includes program instructions, stored on at least one of the one or more computer-readable tangible data storage devices, to collect sets of topic-specific metadata for one or more topics from one or more maps of topics within a set of topic-specific documents. The computing system further includes program instructions, stored on at least one of the one or more computer-readable tangible data storage devices, to store, for each of the sets of topic-specific metadata, a list of pairs of values, wherein each pair of values in the list comprises a context value indicating one of the maps or one of the topic-specific documents that defines a topic-specific metadata value, and the topic-specific metadata value. The computing system further includes program instructions, stored on at least one of the one or more computer-readable tangible data storage devices, to read, for each of the topics identified by the topic-specific metadata, one or more search properties for the topic from the corresponding topic-specific document. The computing system further includes program instructions, stored on at least one of the one or more computer-readable tangible data storage devices, to update, for each of the sets of topic-specific metadata, the list of pairs of values for the set of topic-specific metadata to the one or more search properties for each of the one or more topics.

In another example, a computer program product includes one or more computer-readable tangible data storage media and program instructions stored on at least one of the one or more computer-readable tangible storage media. The computer program product includes program instructions, stored on at least one of the one or more computer-readable tangible data storage media, to collect sets of topic-specific metadata for one or more topics from one or more maps of topics within a set of topic-specific documents. The computer program product further includes program instructions, stored on at least one of the one or more computer-readable tangible data storage media, to store, for each of the sets of topic-specific metadata, a list of pairs of values, wherein each pair of values in the list comprises a context value indicating one of the maps or one of the topic-specific documents that defines a topic-specific metadata value, and the topic-specific metadata value. The computer program product further includes program instructions, stored on at least one of the one or more computer-readable tangible data storage media, to read, for each of the topics identified by the topic-specific metadata, one or more search properties for the topic from the corresponding topic-specific document. The computer program product further includes program instructions, stored on at least one of the one or more computer-readable tangible data storage media, to update, for each of the sets of topic-specific metadata, the list of pairs of values for the set of topic-specific metadata to the one or more search properties for each of the one or more topics.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a block diagram of an example enterprise computing environment that includes an enterprise content management system.

FIG. 2 is a conceptual diagram of a DITA map organization in a metadata and content data store as part of an enterprise content management system.

FIG. 3 is a block diagram of an example computing environment that includes enhanced autoclassifying of content in an enterprise content management system.

FIG. 4 is a flowchart illustrating operation of an example method for enhanced autoclassifying of content in an enterprise content management system.

FIG. 5 is a block diagram of an example computing device that may be used for implementing all or part of a method for enhanced autoclassifying of content in an enterprise content management system.

### DETAILED DESCRIPTION

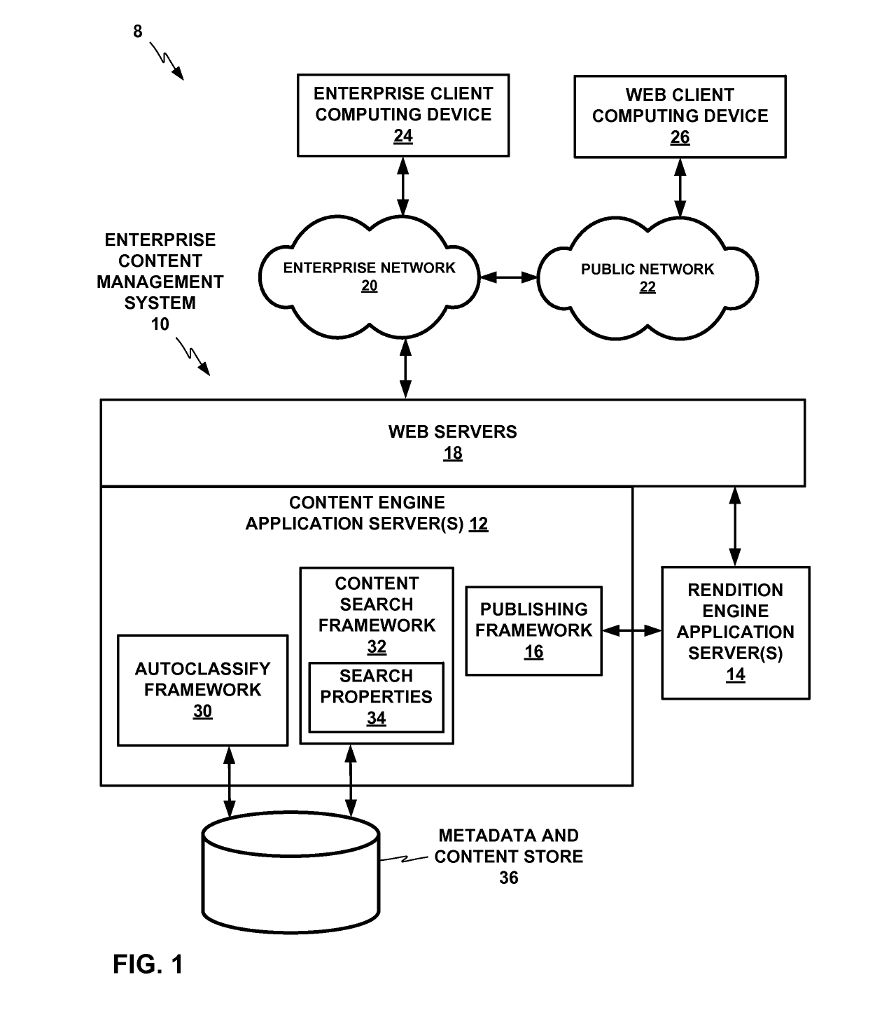

There are set forth herein examples of techniques, methods, computing systems, and computer program products to provide enhanced autoclassifying of content in a content management system. Techniques disclosed herein provide enhanced autoclassifying that may include processing new metadata from a map to apply to topics linked from the map, to a branch of the map to apply to a subset of topics, or to a specific reference to a topic, that is not only reflected in the properties of that map file, but also collect all the topic-specific metadata and then propagate that metadata into the search properties of each topic affected by the new metadata. Thus, instead of metadata enabling a search only to locate the map, and then leave a user to read and parse the markup code of DITA XML themselves to determine which topics the search values apply to, techniques of this disclosure instead provide a methodology by which an Autoclassify program for a DITA map can not only set properties of the map file itself, but also collect all the topic-specific metadata and then propagate that metadata into the search properties of each impacted topic file. One example implementation may be applied for using DITA within an enterprise content management system, and may add a layer of functionality and may improve the user experience in context-dependent searches within a content management engine. Various illustrative features and advantages for enhanced autoclassifying of content in a content management system are further described below with reference to FIGS. 1-5.

FIG. 1 is a block diagram of an example enterprise computing environment 8 that includes an enterprise content management system 10 and various other systems and computing devices, according to an illustrative example. Enterprise content management system 10 includes one or more content engine application servers 12 that may implement, execute, or embody software and/or hardware for features such as an autoclassify framework 30. Enterprise content management system 10 may also include a publishing framework 16 that publishes organized or finished units of content to one or more rendition engine application servers 14, a different part of the enterprise computing environment 8 which may function to render content outputs from content engine application servers 12 into published or deliverable formats, such as HTML documents, PDF documents, etc. for publication within enterprise computing environment 8 or to public network 22. Content engine application servers 12 and rendition engine application servers 14 may interact with web servers 18 which exchange data via enterprise network 20 with enterprise client computing devices 24 and with public network 22 and thereby to web client computing devices 26.

Autoclassify framework 30 may be configured for automatically classifying key content from metadata and content store 36 into metadata that may be stored both in metadata and content store 36, and in search properties 34 in content search framework 32 on content engine application servers 12. Autoclassify framework 30 may thereby facilitate an enhanced capability for searching and collecting content stored in metadata and content store 36, and for providing automatically classified topic-specific metadata from a topic file to a set of search properties for the topic to query for topics. For example, autoclassify framework 30 may parse content from topic files stored in metadata and content store 36, and store topic-specific metadata based on the parsed content as search properties 34 in a content engine running on content engine application servers 12, as further explained below.

Autoclassify framework 30 may be implemented in any of a wide variety of types of software, including as applications running on respective application servers, for example. In one example, autoclassify framework 30 may be written in Java, while in other examples, autoclassify framework 30 may be written in C, C++, C#, Objective-C, JavaScript, Python, Ruby, or any other language. In the example of FIG. 1, content engine application servers 12 are communicatively connected to metadata and content store 36 which may be hosted on storage servers, a storage area network (SAN), a redundant array of independent discs (RAID), or other form of distributed storage or other storage implementation. Metadata and content store 36 may also encompass a database or other data store to hold DITA maps and topics and other data.

In an example of enterprise content management system 10 implemented in Java using the Darwin Information Typing Architecture (DITA), DITA files may be stored along with various other kinds of document content in enterprise content management system 10 as Document objects. The Document class may be extended to include subclasses that represent topics (DitaBase), maps (DitaMap), and processing profiles (DitaVal). The DitaBase and DitaMap classes have a rich set of metadata that maps to key DITA elements and attributes that may facilitate a powerful query capability using content search framework 32 as shown in FIG. 1 to query for topics.

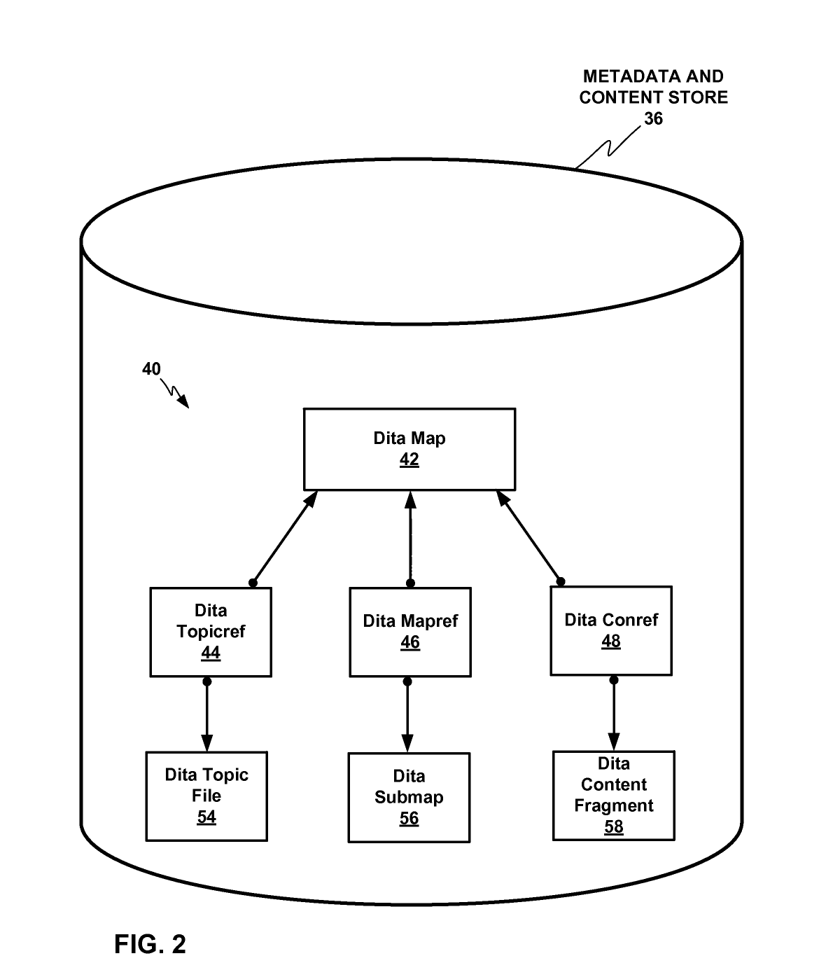

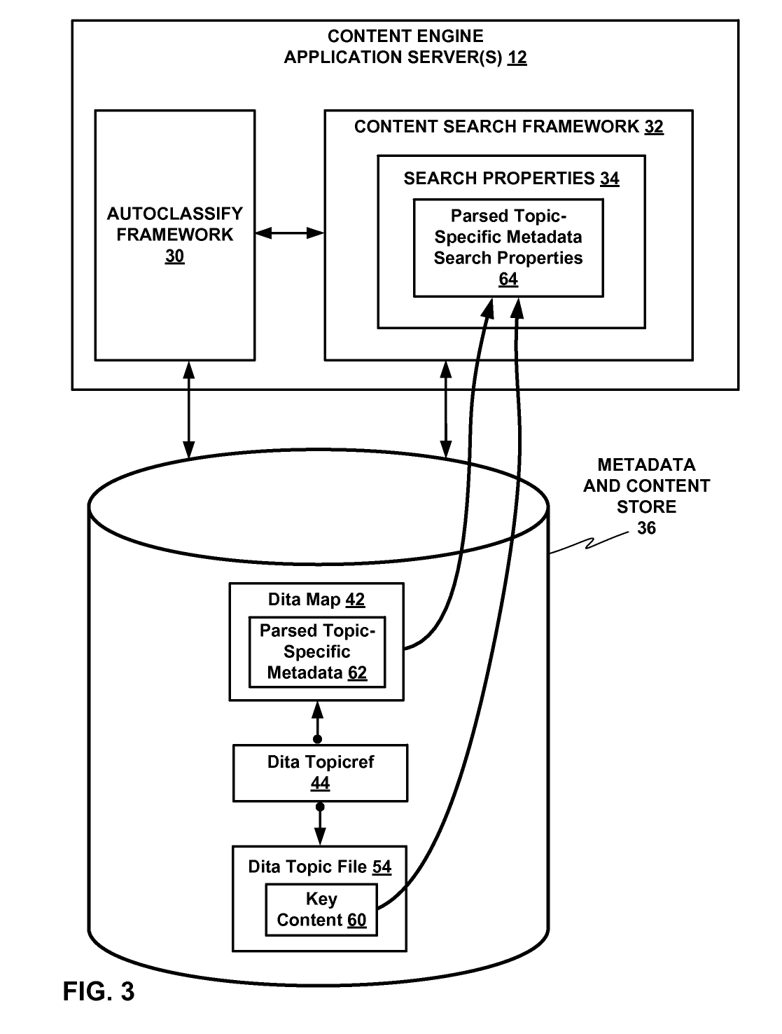

FIG. 2 is a conceptual diagram of a DITA data structure 40 stored in a metadata and content data store 36 as part of an enterprise content management system 10 as in FIG. 1. Data structure 40 includes a DITA map file 42 linked by various relationships to child files or other child objects that form a tree structure linked to DITA map 42 as the parent object of the tree. In particular, DITA map file 42 is linked by one or more DITA Topicref (i.e. topic reference) relationships 44 to one or more DITA Topic files 54; by one or more DITA Mapref (i.e. map reference) relationships 46 to one or more DITA Submap objects 56; and by one or more DITA Conref (i.e. content reference) relationships 48 to one or more DITA Content Fragment files 58. DITA map file 42 may include metadata indicating the tree structure organization of DITA data structure 40 and the nature of the content in the various files and other objects linked therein. At least some of this metadata in DITA map file 42 about DITA data structure 40 and the content in the various files and other objects may be generated by autoclassify framework 30 based on parsing of the content in those files and other objects, such as DITA Topic files 54, DITA Submap objects 56, and DITA Content Fragment files 58. An example of this is illustrated in FIG. 3.

FIG. 3 is a block diagram of an example computing environment that includes enhanced autoclassifying of content in a content engine implemented on content engine application servers 12 (also referred to simply as “content engine 12”). Autoclassify framework 30 in the content engine 12 may parse content in the topic files 54, thereby identifying and parsing key content 60. Autoclassify framework 30 may then add this parsed key content 60 as topic-specific search properties 64. Autoclassify framework may also parse a map file 42 which has links to a topic file 54. In parsing, the Autoclassify framework 30 identifies topic-specific metadata 62 associated with the linked topic 54 and merges that metadata with the search properties 64 for the topic file. Autoclassify framework 30 may add this parsed key content 60 as parsed topic-specific metadata search properties 64, i.e. topic-specific metadata based on the parsed content, to search properties 34 in the content search framework 32, where the parsed topic-specific metadata search properties 64 become included with the search properties 34 in the content engine 12. Autoclassify framework 30 may therefore provide automatically classified topic-specific metadata from a map file to a set of search properties for querying topics, in this example. Therefore, in this example, autoclassify framework 30 enables a user engaging with content engine 12 to perform a query of topics, and receive structured content instead of metadata markup code such as DITA XML in response to the query. The resulting structured content may be structured in accordance with the structure of the query.

Autoclassify framework 30 may include a design for encoding the values of the metadata for the search properties of the topic files (i.e., the topics). For a given topic, the values for a single search property could come from the content of the topic itself or from one or more maps that include that topic, i.e., maps that include mapping information that indicates that topic. Autoclassify framework 30 may go through one or more runs against either a given topic or its referencing maps, and for each run, the values from that topic file may be updated, while no change is made to values that were set from other contexts. In addition to having a design that enables the autoclassify framework 30 to recognize metadata values parsed from the topic file content, autoclassify framework 30 may also enable a user viewing the property values to be able to determine the context from which a given value was set. For example, each of the metadata search properties 64 may be defined as a list of pairs of values. The first item in a given pair of values may identify a context, i.e., the map or topic that originally defined the value, and the second item in the pair may provide the actual attribute value parsed from the topic.

Autoclassify framework 30 may include a collector class or subclasses for use when classifying a map. These autoclassify collector class or subclasses (collectively referred to as “collector class”) may collect all available topic-specific metadata until they have read an entire map. In DITA architecture, it is valid for a single topic to be included within the same map multiple times with the same or different metadata associated with each reference, or each instance of the topic in the map. The collector class may combine these values according to specific installation needs, and may resolve the values to preserve only the unique set, eliminating any exact duplicates.

When the collector class has processed the complete map and collected and prepared the topic-specific metadata, a push method within the collector class may begin the work of pushing the metadata to the topic-specific search properties 64 in the content engine. For each topic, autoclassify framework 30 may retrieve a corresponding topic document in the content engine, load its current set of properties, merge each new metadata value from the map into the current value from the topic, and then set the newly merged property value on the topic document in the content engine.

For example, the search properties 34 in the content engine 12 may include a topic document. Pushing the topic-specific metadata based on the parsed content from the topic file 54 and the topic-specific metadata from the map 42 to the search properties 34 in the content engine 12 may include merging the topic-specific metadata based on the parsed content 60 from the topic file 54 and the topic-specific metadata from the map 42 into properties of the topic document in the content engine 12.

The autoclassify program may therefore recognize certain properties in a map as being not properties of the map itself, but properties of the topics that the map has links or relationships to, that are referenced in the map. The autoclassify program may then take that metadata from the map content and add that to the metadata of the pre-existing topic document in the content engine, so now the article has some metadata that came straight from the topic file, and some metadata that came from the map. When a user subsequently performs a search involving a given property, if it's a property related to the topic, i.e. a topic-level property, the search result may include the topic itself rather than just the map.

In one example, an autoclassify program (such as autoclassify framework 30 in the example of FIG. 3) may read a map 42 and push attribute values from <topicref> tags from the map into search properties 34 of specific topics. The autoclassify program may handle cases in which a single topic is referenced by multiple maps.

Since values may be set in multiple sources (the topic, one or more DITA maps), an autoclassify program may save the property values in pairs, such that the first value in the pair identifies a source from which the value was extracted, and the second value in the pair provides the actual attribute value.

In an example implementation, the first value in a given pair, i.e., the item that identifies the source entry, may be of the format filename.ext [path1, path2, path3]. This may allow the user to quickly scan for the unique map name, usually enough to determine which document was the source, but also provide a backup folder location in case there are multiple maps of the same name. The pathing may be put second because it may be lengthy and may limit the amount of scrolling if the map name itself is sufficient.

For example, there may be three different maps all pointing to the same topic:

| | |
|---|---|
| map1.ditamap contains | <topicref href=”pet.dita” activity=”feeding” |
| | product=”Brand X”>; |
| map2.ditamap contains | <topicref href=”pet.dita” activity=”feeding” |
| | product=” Brand Y”> |
| map3.ditamap contains | <topicref href=”pet.dita” product=” Brand Z”> |

After an autoclassify program checks in all three maps, a topic file named pet.dita may contain the following properties for activity:

map1.ditamap [path]
feeding
map2.ditamap [path]
feeding

The topic file named pet.dita may contain the following properties for product:

map1.ditamap [path]
Brand X
map2.ditamap [path]
Brand Y
map3.ditamap [path]
Brand Z

If the same topic is referenced multiple times in the same map, the autoclassify program may combine the values into a single comma-delimited list with duplicates resolved. For example, if map1.ditamap contained all three of these references:

<topicref href=”pet.dita” product=”Brand X”>
<topicref href=”pet.dita” product=”Brand Z”>
<topicref href=”pet.dita” product=”Brand X”>

The autoclassify program may set the Product property for pet.dita as:

map1.ditamap [path]
Brand X, Brand Z

The core in the autoclassify code for the autoclassify program may function to create a new internal class to store the topic-level metadata as the content of the map is parsed. This may, for example, be done as a complex table.

As the autoclassify program processes each topicref to create the child document link of the compound document, the autoclassify program has already resolved the string value for that target child document (childDocName) and retrieved the actual content engine pointer to that document (childDocument). This information may be used to set the first two columns of the table for easy retrieval for later processing. The last column of the table may be a hashmap to keep track of whichever metadata attributes are coded within this map for this particular child document. An addValuePair( ) method may manage adding values to that attributeInputTable to ensure that any duplicates are eliminated. Since these attributes may contain any of a wide variety of content and of potentially significant difference, each individual attribute value may be preserved as is and an exact compare performed.

When the autoclassify program is ready to push these attribute values out to the properties of the individual topics, a processTable method may be used to read though all the collected metadata and process it one document at a time. Before pushing the value for a given property of the document, the process may first read its current value set (where the values are pairs of values map and attribute value) and then either update the existing value if this map is already present, or add to the list if this map is not listed. The autoclassify program may validate both the map name and the path. A getAttributeTable method may convert the original collection table into a simple hashmap of attribute name as the key and the comma delimited list of values.

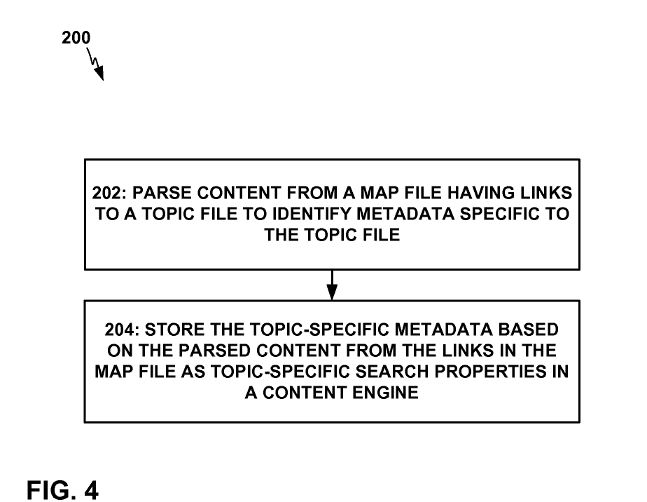

FIG. 4 is a flowchart illustrating operation of an example method 200 for one or more computing devices, such as content engine application servers 12 as depicted in FIGS. 1 and 3, to provide enhanced autoclassifying of content, such as in enterprise content management system 10 of FIG. 1. Method 200 is illustratively described as follows with reference to the examples depicted in FIGS. 1-3. In these examples, it may be understood that when autoclassify framework 30 as depicted in FIGS. 1 and 3 performs a function or task, this may take the form of aspects of that function or task being performed or executed by a computing device or one or more processors of a computing device that are executing autoclassify framework 30 or a portion thereof, or comparable software code. For example, functions or tasks performed by autoclassify framework 30 may be performed or executed by content engine application servers 12 or one or more processors thereof. In various examples, aspects of functions or tasks of autoclassify framework 30 may be performed or executed by the same computing device or the same processor, or may be performed by more than two different servers or other computing devices, including by being performed by one or more virtual machines or virtual servers that may run on an abstracted layer spread across multiple computing devices or multiple data centers, for example.

In the example of method 200, one or more computing devices, such as one or more content engine application servers 12 running autoclassify framework 30, parses content from a map file 42 having links to a topic file 54 in the metadata and content store 36 to identify metadata specific to the topic file 54 (202). The one or more content engine application servers 12 then store topic-specific metadata 64 based on the parsed content from links in the map file as topic-specific search properties 34 for the associated topic in the content engine 12 (204).

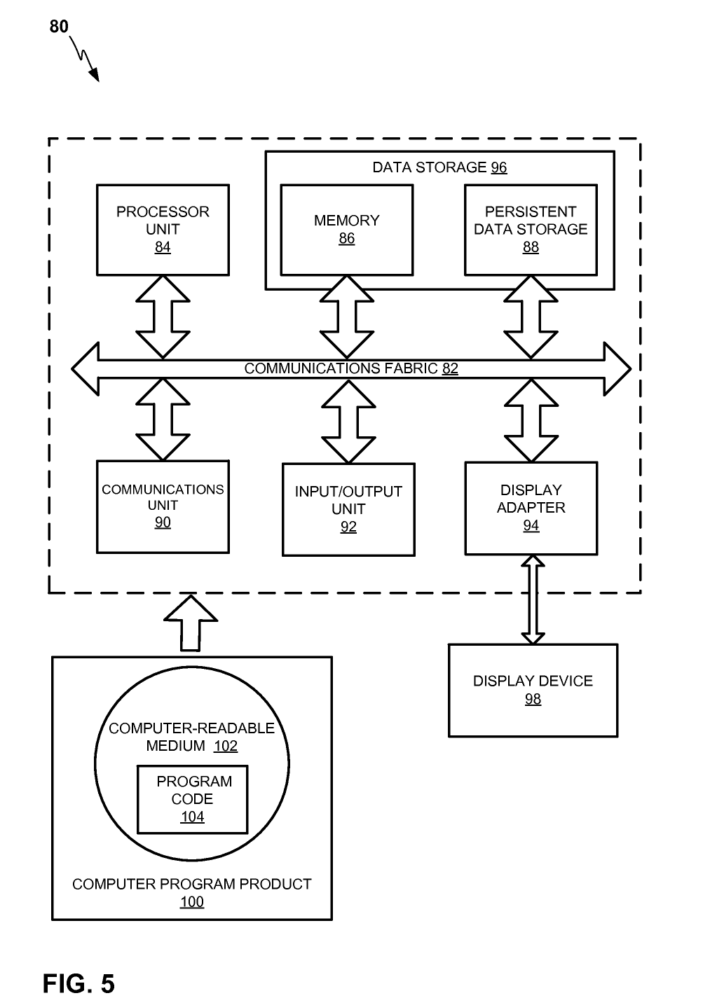

FIG. 5 is a block diagram of an example computing device 80 that may be used for implementing all or part of a method for enhanced autoclassifying of content in an enterprise content management system, according to an illustrative example. Computing device 80 may be a workstation, server, mainframe computer, notebook or laptop computer, desktop computer, tablet, smartphone, feature phone, or other programmable data processing apparatus of any kind. Computing device 80 of FIG. 5 may represent any of content engine application servers 12 as depicted in FIGS. 1 and 3, for example. Content engine application servers 12 of FIGS. 1 and 3 may also be implemented as virtual servers, either or both of which may execute on computing device 80 of FIG. 5, or on multiple computing devices that may include computing device 80 of FIG. 5. Any combination or all of the processes and capabilities disclosed herein may execute on computing device 80 or a combination of similar computing devices that may be implemented in a data center or a cloud data service with multiple redundant data centers, or in any other configuration. Other possibilities for computing device 80 are possible, including a computer having capabilities or formats other than or beyond those described herein. Computing device 80 may execute an autoclassify framework 30 as depicted in FIGS. 1 and 3 or another computer program or portion of software that contributes to providing enhanced autoclassifying of content in an enterprise content management system. An enhanced autoclassifying system may be enabled to provide enhanced autoclassifying of content in an enterprise content management system either by incorporating this capability natively, or adding it via a plug-in, add-on, or macro, or by running a separate program that modifies a pre-existing framework, for example.

In this illustrative example, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, but those skilled in the art will recognize that this also constitutes an example of a physical, tangible, non-transitory computer-readable data storage device. Executable instructions are stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a dynamic property data integration framework, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, a mobile device operating system such as iOS® from Apple® Inc., or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. Some of these examples may overlap with each other, or with example components of communications unit 90 or data storage 96. Input/output unit 92 may also include appropriate device drivers for any type of external device, or such device drivers may reside in the operating system or elsewhere on computing device 80 as appropriate.

Computing device 80 also includes a display adapter 94 in this illustrative example, which provides one or more connections for one or more display devices, such as display device 98, which may include any of a variety of types of display devices, including monitor 132 of FIG. 2. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology. Computer program code 104 may include a computer program, module, or portion of code for providing enhanced autoclassifying of content in an enterprise content management system as described above.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing processor unit 84 to generate physical outputs that correspond to the computer-executable instructions, in a way that modifies computing device 80 into a new physical state and causes computing device 80 to physically assume new capabilities that it did not have until its physical state was changed by loading the executable instructions comprised in program code 104.

In some illustrative examples, program code 104 may be downloaded over a network to data storage 96 from another device or computer system, such as a server, for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

Computing device 80 of FIG. 5 may be an implementation of content engine application servers 12 of FIGS. 1 and 3. In enterprise computing environment 8 of FIG. 1, enterprise network 20 and other communicative connections among the elements of enterprise computing environment 8 may include one or more networks of any kind that may provide communications links between various devices and computers connected together within enterprise computing environment 8. Enterprise network 20 and other communicative connections in enterprise computing environment 8 may include connections, such as wire, wireless communication links, or fiber optic cables. In one example, public network 22 is the Internet with a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Enterprise network 20 may also be implemented as a number of different types of networks, such as for example, an intranet, a local area network (LAN), or a wide area network (WAN). FIG. 1 is an illustrative example, and not an architectural limitation for the variety of illustrative examples.

Content engine application servers 12 may include any type of servers, and metadata and content store 36 may include any type of storage server, storage area network, redundant array of independent discs (RAID), storage device, cloud storage service, or any other type of data storage. Enterprise content management system 10 may also include additional servers, clients, storage elements, network elements, and various other devices not shown in FIG. 1 that may also be involved in enabling techniques of this disclosure.

Enterprise client computing device 24 as depicted in FIG. 1 may be connected to content engine application servers 12 via any hard-line, wireless, or network connection. Enterprise client computing device 24 may have various user input/output devices operatively connected to it to enable detecting user inputs and providing user-perceptible output, such as a keyboard, a mouse 138, and a monitor which may render a graphical user interface for a client application operatively connected to content engine application servers 12, enabling a user to interact with content engine application servers 12 such as to perform searches of content in metadata and content store 36.

As will be appreciated by one skilled in the art, aspects of the present invention may be embodied as a method, a computing system, or a computer program product, for example. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, aspects of the present invention may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible, non-transitory data storage medium, as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, electrooptic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wireline, optical fiber cable, etc., or any suitable combination of the foregoing. Computer program code for carrying out operations for aspects of the present invention may be written in any combination of one or more programming languages, such as Java, Smalltalk, C, C++, C#, Objective-C, JavaScript, Python, Ruby, or any other language. One or more portions of applicable program code may execute partly or entirely on a user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures.

A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided as computer-executable code to a processor of a general purpose computer, special purpose computer, or other programmable data processing apparatus to produce a machine, such that the instructions, which execute via the processor of the computer or other programmable data processing apparatus, may create means for implementing the functions or acts specified in the flowchart and/or block diagram block or blocks.

These computer program instructions may also be stored in a computer readable medium that can cause a computer, other programmable data processing apparatus, or other devices to function in a particular manner, such that the executable instructions stored in the computer readable medium transform the computing device into an article of manufacture that embodies or implements the functions or acts specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer implemented process such that the instructions which execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). In some implementations, the functions noted in the block may occur out of the order noted in the figures. For example, two blocks shown in succession may, in fact, be executed substantially concurrently, or the blocks may be executed in a different order, or the functions in different blocks may be processed in different but parallel threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or in any combination of special purpose hardware and computer-executable instructions running on general purpose hardware.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable persons of ordinary skill in the art to understand the disclosure for various embodiments with various modifications as are suited to the particular use contemplated. The various examples described herein and other embodiments are within the scope of the following claims.

What is claimed is:

1. A method, performed by one or more processors, for providing automatically classified topic-specific metadata from a map file to a set of search properties associated with the topic file, the method comprising:
parsing content from the map file; and
storing topic-specific metadata based on the parsed content from the links in the map file as search properties in a content engine.

2. The method of claim 1, further comprising storing the topic-specific metadata based on the parsed content in content maps that link to the topic files.

3. The method of claim 1, further comprising, for each of the sets of topic-specific metadata, storing a list of pairs of values, wherein each pair of values in the list comprises a context value and an attribute value.

4. The method of claim 3, wherein the context value is based on context metadata from a map that links to the topic file.

5. The method of claim 3, wherein the attribute value is based on the parsed content from the map file.

6. The method of claim 1, further comprising, for each of a plurality of topic files identified by the topic-specific metadata, reading one or more search properties for the topic from the corresponding topic file.

7. The method of claim 1, further comprising storing a plurality of sets of topic-specific metadata based on parsed content from a plurality of topic files, and updating a list of pairs of values for the set of topic-specific metadata to the one or more search properties in a content engine for each of the topic files.

8. The method of claim 7, wherein updating the list of pairs of values for the set of topic-specific metadata to the one or more search properties comprises eliminating one or more pairs of values that comprise context-specific map values from topic maps paired with an identical attribute value from the topic file.

9. The method of claim 7, wherein updating the list of pairs of values for the set of topic-specific metadata to the one or more search properties comprises adding pairs of context and attribute values for the set of topic-specific metadata to the one or more search properties.

10. The method of claim 9, wherein the pairs of context and attribute values comprise a context-specific map value from the topic map and an attribute value based on the parsed content from the topic file.

11. The method of claim 1, further comprising storing topic-specific metadata from a map that links to the topic file, in association with the topic-specific metadata based on the parsed content from the topic file.

12. The method of claim 1, further comprising pushing the topic-specific metadata based on the parsed content from the topic file and the topic-specific metadata from the map to the search properties in the content engine.

13. The method of claim 12, wherein the search properties in the content engine comprise a topic document in the content engine, and wherein pushing the topic-specific metadata based on the parsed content from the topic file and the topic-specific metadata from the map to the search properties in the content engine comprises merging the topic-specific metadata based on the parsed content from the topic file and the topic-specific metadata from the map into properties of the topic document in the content engine.

14. The method of claim 1, further comprising:
receiving a query input;
performing a search of the topic-specific metadata in the content engine based on properties comprised in the query input; and
outputting a topic document comprising content from the topic file indicated by the search of the topic-specific metadata in the content engine.

15. A computing system comprising:
one or more processors;
one or more computer-readable tangible data storage devices;
program instructions, stored on at least one of the one or more computer-readable tangible data storage devices, to collect sets of topic-specific metadata for one or more topics from one or more maps of topics within a set of topic-specific documents;
program instructions, stored on at least one of the one or more computer-readable tangible data storage devices, to store, for each of the sets of topic-specific metadata, a list of pairs of values, wherein each pair of values in the list comprises a context value indicating one of the maps or one of the topic-specific documents that defines a topic-specific metadata value, and the topic-specific metadata value;
program instructions, stored on at least one of the one or more computer-readable tangible data storage devices, to read, for each of the topics identified by the topic-specific metadata, one or more search properties for the topic from the corresponding topic-specific document; and
program instructions, stored on at least one of the one or more computer-readable tangible data storage devices, to update, for each of the sets of topic-specific metadata, the list of pairs of values for the set of topic-specific metadata to the one or more search properties for each of the one or more topics.

16. The computing system of claim 15, further comprising program instructions, stored on at least one of the one or more computer-readable tangible data storage devices, to store a plurality of sets of topic-specific metadata based on parsed content from a plurality of topic files, and update a list of pairs of context and attribute values for the set of topic-specific metadata to the one or more search properties in a content engine for each of the topic files, wherein the pairs of context values comprise context-specific map values from the topic map, and the attribute values are based on the parsed content from the topic file.

17. The computing system of claim 15, further comprising program instructions, stored on at least one of the one or more computer-readable tangible data storage devices, to push the topic-specific metadata based on the parsed content from the topic file and the topic-specific metadata from the map to the search properties in the content engine, wherein the search properties in the content engine comprise a topic document in the content engine, and wherein pushing the topic-specific metadata based on the parsed content from the topic file and the topic-specific metadata from the map to the search properties in the content engine comprises merging the topic-specific metadata based on the parsed content from the topic file and the topic-specific metadata from the map into properties of the topic document in the content engine.

18. A computer program product comprising:
one or more computer-readable tangible data storage media;
program instructions, stored on at least one of the one or more computer-readable tangible data storage media, to collect sets of topic-specific metadata for one or more topics from one or more maps of topics within a set of topic-specific documents;
program instructions, stored on at least one of the one or more computer-readable tangible data storage devices, to store, for each of the sets of topic-specific metadata, a list of pairs of values, wherein each pair of values in the list comprises a context value indicating one of the maps or one of the topic-specific documents that defines a topic-specific metadata value, and the topic-specific metadata value;
program instructions, stored on at least one of the one or more computer-readable tangible data storage devices, to read, for each of the topics identified by the topic-specific metadata, one or more search properties for the topic from the corresponding topic-specific document; and
program instructions, stored on at least one of the one or more computer-readable tangible data storage devices, to update, for each of the sets of topic-specific metadata, the list of pairs of values for the set of topic-specific metadata to the one or more search properties for each of the one or more topics.

19. The computer program product of claim 18, further comprising program instructions, stored on at least one of the one or more computer-readable tangible data storage media, to store a plurality of sets of topic-specific metadata based on parsed content from a plurality of topic files, and update a list of pairs of context and attribute values for the set of topic-specific metadata to the one or more search properties in a content engine for each of the topic files, wherein the pairs of context values comprise context-specific map values from the topic map, and the attribute values are based on the parsed content from the topic file.

20. The computer program product of claim 18, further comprising program instructions, stored on at least one of the one or more computer-readable tangible data storage media, to push the topic-specific metadata based on the parsed content from the topic file and the topic-specific metadata from the map to the search properties in the content engine, wherein the search properties in the content engine comprise a topic document in the content engine, and wherein pushing the topic-specific metadata based on the parsed content from the topic file and the topic-specific metadata from the map to the search properties in the content engine comprises merging the topic-specific metadata based on the parsed content from the topic file and the topic-specific metadata from the map into properties of the topic document in the content engine.
